(19) United States
(12) Patent Application Publication
(10) Pub. No.: US 2004/0152613 A1
(43) Pub. Date: Aug. 5, 2004

(54) Detergent compositions

(76) Inventors: Dirk Develter, Maldegem (BE); Mark Renkin, Wiekevorst (BE); Ilse Jacobs, Vorselaar (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/761,200

(22) Filed: Jan. 22, 2004

(30) Foreign Application Priority Data
Jan. 28, 2003 (EP) 03447018.7

(51) Int. Cl. C11D 17/00

(52) U.S. Cl. 510/421; 510/505

(57) ABSTRACT

The present invention relates to detergent compositions comprising at least one glycolipid biosurfactant and at least one non-glycolipid surfactant, whereby the at least one glycolipid biosurfactant and the at least one non-glycolipid surfactant are in the micellar phase.

The present invention relates to detergent compositions comprising at least one glycolipid biosurfactant and at least one non-glycolipid surfactant.

The use of glycolipid biosurfactants in detergents is known in the art. Glycolipid biosurfactants include rhamnolipids, sophorolipids, glucoselipids, cellobioselipids and trehaloselipids and (bio)chemical modifications thereof. Glycolipid biosurfactants can be produced by microbial cultivation. This offers the advantage that they can be derived from renewable raw materials and that they are likely to be biodegradable after use.

From EP-B-0,499,434 a detergent composition for the washing of fabrics, dishes and household surfaces is known comprising (1) a micellar phase surfactant, in particular a glycolipid biosurfactant, and (2) a lamellar phase surfactant which is either a non-glycolipid surfactant or a glycolipid biosurfactant. According to EP-B-0,499,434 the glycolipid micellar biosurfactant gives a synergistic enhancement of the oily/fatty soil detergency when used in combination with a lamellar phase surfactant.

Micellar and lamellar phase surfactants may be distinguished by the behaviour of a 1% by weight aqueous solution in demineralised water at pH 7.0 and 25° C. A surfactant solution containing dispersed lamellar phases exhibits birefringent textures when viewed under a polarising optical microscope, while a micellar does not. In general, a micellar phase surfactant will provide a clear solution when present at a concentration of 1% by weight in demineralised water at pH 7.0 and 25° C., although the presence of small amounts of impurities may reduce the clarity. A lamellar phase surfactant will always provide a cloudy solution when present at a concentration of 1% by weight in demineralised water at pH 7.0 and 25° C.

U.S. Pat. No. 5,417,879 discloses a detergent composition suitable for washing fabrics. The detergent composition comprises a sophorolipid biosurfactant and a lamellar phase surfactant, being either a non-glycolipid surfactant or a glycolipid biosurfactant.

From U.S. Pat. No. 5,520,839 a detergent composition suitable for washing fabrics is known. The detergent composition comprises a sophorolipid biosurfactant and a non-glycolipid lamellar phase non-ionic surfactant.

However, ethoxylated nonionics, which make up the vast majority of the prior art lamellar non-glycolipid surfactants used in the detergent compositions described in the above mentioned patent applications, have the disadvantage that, when used in a detergent composition for cleaning household surfaces, they cause an undesired stress cracking on polycarbonate and other plastic surfaces and tend to be hard to rinse off. They further present the disadvantage of causing too much foaming of the detergent composition, resulting in a hindered mechanical action of the laundry machine.

From DE-196,00,743, a detergent composition for the manual cleaning of dishes is known comprising a glycolipid and a non-glycolipid surfactant. The combination of a glycolipid biosurfactant with a non-glycolipid surfactant show a synergistic enhancement of the rinsing, dispersing and foaming performance of the detergent composiiton. DE-196,00,743 does however not specify the phase (lamellar or micellar) in which the glycolipid biosurfactant or the non-glycolipid biosurfactant are present in the detergent composition.

It is the object of the present invention to provide an alternative detergent composition, which is suitable to use as hard surface cleaner, but also for use as a laundry composition.

This is achieved with the technical features of the characterising part of the first claim.

It has surprisingly been found with the present invention that when combining at least one glycolipid biosurfactant which is in the micellar phase and at least one non-glycolipid surfactant which is also in the micellar phase, a synergistic enhancement of the detergency is obtained. It has further been observed that the foaming of the detergent compositions of the present invention can be kept low, rendering the detergent compositions suitable as hard surface cleaner, but sufficient to render them suitable as a laundry composition. In addition to this, their aquatic toxicity is low and their renewability is complete. A synergistic enhancement of detergency is understood to occur when the combination of the glycolipid micellar phase biosurfactant with the non-glycolipid micellar phase surfactant gives an improved detergency as compared to the non-glycolipid or glycolipid micellar phase surfactant alone, the total amount of surfactant being the same.

Moreover, in the present invention, the need to the use of ethoxylated nonionics, which make up the vast majority of prior art lamellar non-glycolipid surfactants, can be dispensed with. This is an advantage since these ethoxylated nonionics cause undesired stress cracking on polycarbonate and other plastic surfaces and tend to be hard to rinse off, rendering them less suited for all purpose cleaning and imposing additional measures in laundry applications, such as the need to add anti-foaming agents.

Consequently, the detergent compositions of this invention comprising a combination of a glycolipid biosurfactant and a non-glycolipid surfactant which are both in the micellar phase are a good, biodegradable alternative for the detergent composition comprising a micellar glycolipid and a lamellar non-glycolipid surfactant known in the art.

Preferably, the glycolipid micellar phase biosurfactant for use in the detergent composition of the present invention is a micellar phase sophorolipid biosurfactant of the formula (I), or a salt of the sophorolipid biosurfactant of formula (I),

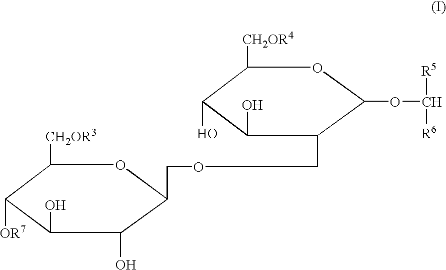

in which

—R³ and R⁴ are independently from each other H or an acetyl group;

—R⁵ is H or a saturated or unsaturated, hydroxylated or non-hydroxylated hydrocarbon group having 1 to 9 carbon atoms

—R⁶ is the group R⁸—CO—R⁹ or the group

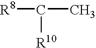

whereby R⁸ is a saturated or an unsaturated, hydroxylated or non-hydroxylated, linear or branched hydrocarbon group having 1 to 20 carbon atoms, the total number of carbon atoms in the groups R⁵ and R⁸ not exceeding 20; R⁹ is CH₃ or OH or cation salt thereof, or an O(CH₂)ₘCH₃ ester thereof with m being an integer between 0 and 3, or a lactone ring formed with R⁷; R¹⁰ is H or OH —R⁷ is H or a lactone ring formed with R⁹;

or a micellar phase rhamnolipid biosurfactant of the formula (II):

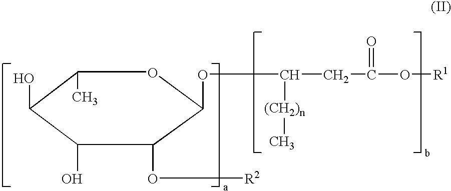

in which a and b independently from each other are 1 or 2, n is an integer from 4 to 10, R¹ is H or a cation, preferably H, R² is H or the group

CH₃(CH₂)ₘCH═CH—CO,

preferably H, m being an integer from 4 to 10, and m and n may be the same or different; or a combination of the micellar phase sophorolipid and rhamnolipid biosurfactant. Common used cations are alkali metal, ammonium and alkanolamine.

Micellar phase sophorolipids are preferred for hard surface cleaning since they have quick and substantially complete foam breaking effects. The foam breaking effect of sophorolipids has been observed both in cold as well as in warm water, rendering the detergent compositions of the present invention suitable both for hard surface cleaning as well as for laundry applications. Combining micellar phase sophorolipids with a micellar phase non-glycolipid surfactant allows both for initial flash foam upon product dilution as well as subsequent foam control. This is an advantage since the presence of initial flash foam reassures the consumer the product is really effective. The subsequent foam control allows to limit the mere foaming of the surfactant. The mere foaming of a surfactant is considered as a disadvantage in hard surface cleaning, since for regular domestic hard surface applications, slowly collapsing foams increase the time needed to rinse away the foam.

Micellar phase rhamnolipids are preferred for laundry applications since they allow the formation of foam to some desirable, although limited extent. Too much foam would result in a mechanical hindering of the laundry machine and is therefore undesired. Moreover, due to this foam inhibiting effect of micellar phase glycolipids, the use of the usual foam controlling agents in the laundry compositions such as silicone oil, paraffin, or soap can be dispended with. This is an advantage since these foam controlling agents have a negative effect on hard surface or laundry cleaning performance and some have low environmental compatibility. Furthermore, in the concentrations used in laundry compositions, the overall detergency of micellar phase rhamnolipids is better as compared to micellar phase sophorolipids, making them further suitable for laundry applications.

This requirement for the low foaming of surfactants in hard surface cleaners and laundry compositions clearly is in sharp contrast to the manual dishwashing liquids disclosed in DE-196,000,743, which are based on strong foaming surfactants and which are tested in the lab using residual foam as criterion, again favouring surfactants that produce very stable foam.

Without wanting to be limited thereto, the inventors are of the opinion that the quick and complete foam breaking effect of micellar phase sophorolipids is due to the binding of hard water ions such as calcium to the carboxylgroup of free acid sophorolipids. The latter is supported by the reduced foam breaking effect by micellar phase sophorolipids in softened water having a low concentration of calcium ions.

Preferably, the micellar phase sophorolipid biosurfactant corresponds to the formula (III):

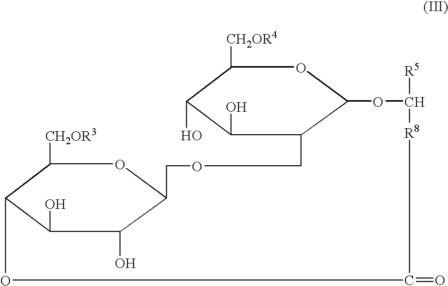

in which R³, R⁴, R⁵ and R⁸ are as defined above, and whereby at least one of R³ and R⁴ is an acetyl group. The above defined sophorolipid shows the best performance.

In another preferred embodiment, the glycolipid micellar phase biosurfactant is a sophorolipid biosurfactant and R⁵ is a methyl group.

In yet another preferred embodiment, the glycolipid micellar phase biosurfactant is a sophorolipid biosurfactant whereby R⁶ is the group R⁸—CO—R⁹ and the total number of carbon atoms of R⁵ and R⁸ is from 6 to 20, R⁵, R⁶, R⁸ and R⁹ being as defined in formula (I). More preferably, R⁵ is CH₃, and R⁸ is an unsaturated linear hydrocarbon chain having 13-15 carbon atoms (corresponding to a total number of carbon atoms of R⁵ and R⁸ of 16-18) or a saturated linear hydrocarbon chain having 6-9 carbon atoms (corresponding to a total number of carbon atoms of R⁵ and R⁸ of 9-12).

Preferably, the glycolipid micellar phase biosurfactant is a sophorolipid biosurfactant corresponding to the formula

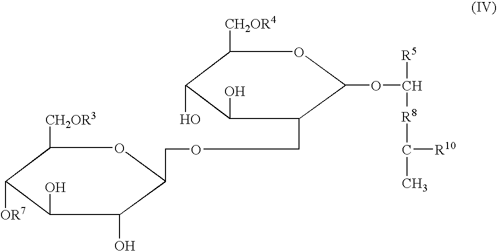

Preferably, in formula (IV) R⁵ is CH₃, R¹⁰ is H and R⁸ is a saturated linear hydrocarbon chain having 8-10 carbon atoms.

In still another preferred embodiment, the glycolipid micellar phase biosurfactant is a rhamnolipid biosurfactant and n is 6.

In still another preferred embodiment, the glycolipid micellar phase biosurfactant is a rhamnolipid biosurfactant and b is 2.

The non-glycolipid micellar phase surfactant for use in the detergent composition of the present invention is not critical to the invention and may be selected from the group of cationic, anionic, non-ionic or amphoteric surfactants, or a combination thereof.

Typical examples of suitable micellar phase anionic surfactants are alcali metal, ammonium or alkanolamine salts of the following substances: C12-18 fatty acids, sulphated C8-18 fatty alcohol, such as sulphated C12-14 or C12-18 fatty alcohols, or ethoxylated C12-15 fatty alcohol sulphates (1-3 EO), C14-16 alfa-olefinesulfonate, C14-17 secundary alkanesulphonate, sulfo C12-18 fatty acid methylester, C10-13 linear alkylbenzenesulfonate, laureth-13 carboxylate, cocomonoglyceride sulfate, . . . . For instance, a fatty alcohol sulphate having C12-14 alkyl chains, such as for example sodium lauryl sulfate is suitable for use in the detergent composition of this invention, both in hard surface cleaners and liquid laundry compositions. The sodium soap of mixed fatty acids and C12-18 fatty alcohol sulphate can be used in solid laundry detergent compositions of this invention, whereas the potassium soap of mixed fatty acids can be used in lquid laundry detergent compositions of this invention.

Typical examples of suitable micellar phase nonionic surfactants are those having a HLB (hydrophilic-lipophylic balance) value of at least 12, such as for example alk(en)polyglucosides (“APG”), e.g. C8-14 or C8-10 alkylpolyglucosides, C12-14 alkyl glucosamides, sucrose laurate, glycerine fatty acid esters, glycereth (6-17 EO) cocoate, cocamine oxide, certain narrow range ethoxylated fatty alcohols, rapeseed methyl ester ethoxylates (10-15 EO) such as rapeseed methylester ethoxylate (10 EO), broad range C9-11 (5 EO) or C12-15 ethoxylated (6-7 EO) fatty alcohols, such as C12-14 fatty alcohol ethoxylated with 7 mol ethyleneoxide, or certain alkoxylated fatty alcohols, . . . .

C6-14 APG's form a birefrigent phase only in almost waterless conditions at a concentration of approximately 80% by weight for C8 APG and 60% by weight for C12-14 APG, but not a concentration of 1% by weight (Nickel, Förster and von Rybinski, 1996). In low concentrations at room temperatures they do not form a birefrigent phase and are present as a clear solution. Since the definition of a micellar phase surfactants is that they provide a clear solution when present at a concentration of 1% by weight in demineralised water at pH 7.0 and 25° C., the above described APG's suitable for use in the detergent compositions of the present invention are to be considered as micellar phase non-glycolipid surfactants.

Typical examples of suitable micellar phase amphoteric surfactants are C12-14 alkyldimethylbetaine, C12-14 alkylamidopropylbetaine, . . . .

The weight ratio of the micellar phase glycolipid biosurfactant with respect to the non-glycolipid micellar phase surfactant in the detergent composition of this invention may be varied within wide ranges and is preferably chosen in such a way as to give a better detergency than given by either the micellar phase glycolipid biosurfactant or the non-glycolipid micellar phase surfactant alone. This weight ratio which gives a synergistic enhanced detergency will in general be adapted to the specific application of the detergent composition and on the cosurfactant added to the detergent composition.

In a preferred embodiment, the weight ratio of the glycolipid micellar phase biosurfactant to the non-glycolipid micellar phase surfactant in the detergent composition of the present invention is within the range of 1:7 to 10:1.

When the glycolipid micellar phase biosurfactant in the detergent composition of the present invention is a micellar phase rhamnolipid, the weight ratio of the glycolipid micellar phase rhamnolipid biosurfactant to the non-glycolipid micellar phase surfactant is preferably within the range of 1:7 to 2:1, more preferably within the range of 1.25:1 to 1:1.25.

When the glycolipid micellar phase biosurfactant in the detergent composition of the present invention is a micellar phase sophorolipid, the weight ratio of the glycolipid micellar phase sophorolipid biosurfactant to the non-glycolipid micellar phase surfactant will preferably be within the range of 1:2 to 10:1 when the detergent composition is used for concentrated applications (such as cream cleaner, roll-on stain remover), of 1:4 to 4:1, preferably 2:1 when the detergent composition is used for general hard surface cleaning. A typical example for the latter is an all purpose cleaner applied to be used either undiluted on a sponge or diluted in tap water.

For example, in a detergent composition, suitable for use as broad application range hard surface cleaning composition, containing an the non-glycolipid micellar surfactant alkylpolyglucoside and the micellar phase sophorolipid glycolipid biosurfactant, the weight ratio of the sophorolipid biosurfactant to alkylpolyglucoside will mostly be within the range of 1:4 to 4:1, preferably 1:2 to 2:1. In a laundry detergent composition containing a micellar phase rhamnolipid, the weight ratio of the rhamnolipid biosurfactant to non-glycolipid micellar surfactant will mostly be within the range of 1:1 to 1:3. In an all purpose cleaning composition, the weight ratio of a rhamnolipid biosurfactant to non-glycolipid micellar surfactant will generally be within the range of 1:1 to 1:7, preferably within the range of 1.25:1 to 1:1.25.

It is also preferred that the amount of the micellar phase glycolipid biosurfactant in the detergent composition of the present invention is at least 0.05% and at most 5.0% by weight with respect to the total weight of the composition. These concentrations correspond to concentrations in practical product between 0.05 and 50 g/l, depending on the product application and the dilution factor upon use. When used as hard surface cleaners, the micellar phase glycolipid biosurfactant generally is present in a concentration of 0.05 to 3% by weight; whereas in laundry detergent compositions, the micellar phase glycolipid biosurfactant will generally be present in a concentration of approximately 2 to 5.0% by weight with respect to the total weight of the composition.

The total amount of the micellar phase glycolipid biosurfactant and non-glycolipid micellar phase surfactant together will mostly vary from 0.3-30% by weight with respect to the total weight of the composition, depending on the application.

The invention further relates to a hard surface cleaning detergent composition comprising an amount of the detergent composition as defined above.

The invention further relates to a laundry composition comprising an amount of the detergent composition as defined above.

Laundry compositions are meant to include heavy duty compact and regular laundry products, delicate wash, wool wash, specialty wash (such as for jeans, black garments, . . . ), stain remover, stain sprays, fabric conditioners, and laundry performance boosting additives or specialty products are considered. Hard surface cleaners are meant to include all purpose cleaners, cream cleanser, glass (window) cleaner, floor and wall cleaner, bathroom cleaner, mould remover, toilet cleaner, kitchen cleaner, oven cleaner, ceramic hob and microwave oven cleaner and polishes are considered.

In practice, the detergent composition of this invention may be used in any suitable form including powders, bars, tablets, liquids, spray and pastes. The liquid detergent compositions may be aqueous or non-aqueous.

The invention is further elucidated in the figures, description of the figures, and examples.

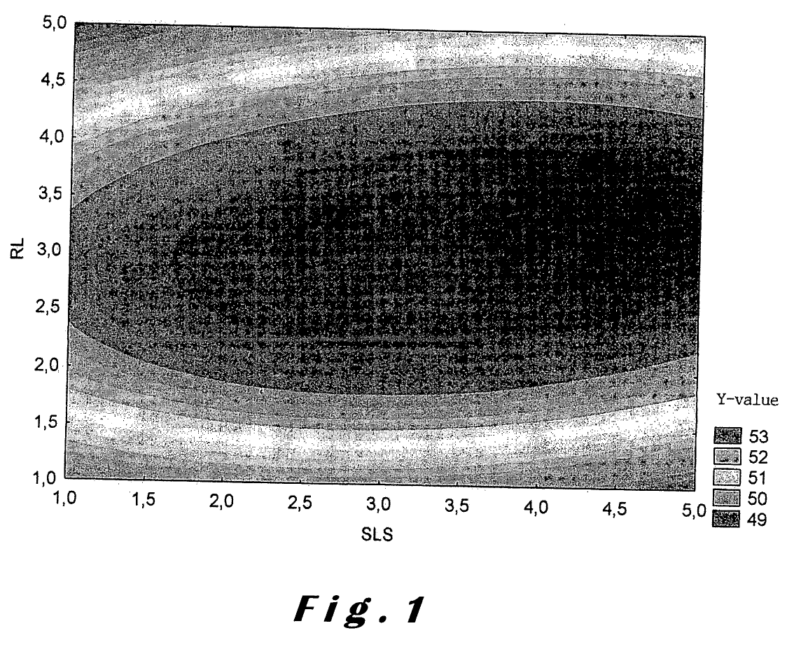

FIG. 1 shows the general detergency (Y-value) of different detergent compositions of the present invention suitable as a laundry composition corresponding to different weight ratios of a mixture of micellar phase rhamnolipid biosurfactants (RL) with respect to the sodium salt of the non-glycolipid micellar phase surfactant C12-14 fatty alcohol sulphate (SLS).

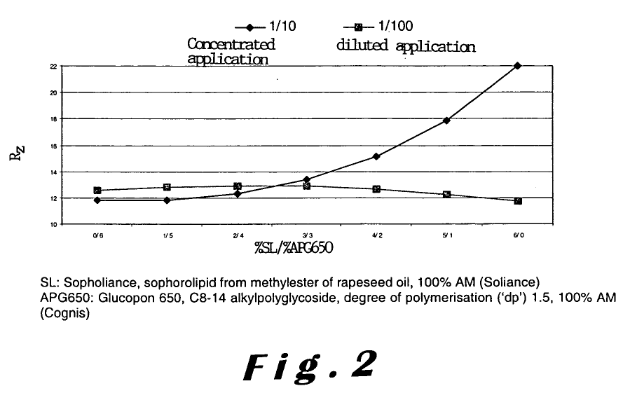

FIG. 2 shows the hard surface cleaning performance (R_{z}) for either a diluted (1/100, squares) or concentrated (1/10, diamonds) form of different detergent compositions of the present invention suitable for us as a hard surface cleaner each time corresponding to different weight ratios of the micellar phase sophorolipide biosurfactant (SL) with respect to the non-glycolipid micellar phase surfactant alkylpolyglucoside (APG650).

The used micellar phase sophorolipide is a mixture of micellar phase sophorolipids having different chain lengths. More than 90% is a sophorolipide in which R⁶ in formula (I) is the group R⁸—CO—R⁹, in which the total number of carbon atoms of R⁵+R⁸ is 18 and whereby R⁶ is an unsaturated hydrocarbon chain. The remaining 10% comprises, amongst others, sophorolipids in which R⁶ in formula (I) is the group R⁸—CO—R⁹, in which the total number of carbon atoms of R⁵+R⁸ is 18 and whereby R⁶ is a saturated hydrocarbon chain, sophorolipids in which R⁶ in formula (I) is the group R⁸—CO—R⁹, in which the total number of carbon atoms of R⁵+R⁸ is 16 and whereby R⁶ is a saturated or an unsaturated hydrocarbon chain.

The general detergency and hard surface cleaning performance are determined by measuring respectively the standard tristimulus colour value Y (lightness) in case of fabrics or the diffuse blue reflection value R_{z} in case of hard surfaces. These calorimetric measures are determined by measuring the reflectance of a light beam directed on to the substrate to be cleaned.

Experimental cleaning was done according to the ‘IPP (Institut für Putz und Pflegemittel)’ test (Kiewert, 1981). Either a concentrated (‘1/10’, 0.5%) or a diluted (‘1/100’, 0.05%) form of the detergent solution are tested. Each time, two PVC strips (A and B) are soiled with a 150μ thin layer of a mixture of carbon black and mineral oil. The mixture is left to air dry for 60 to 90 minutes, after which the strips are fixed onto a Gardner apparatus (Washability Model 1721, Braive Instruments). Then, 10 ml of the detergent solution (either the concentrated or the diluted solution) is applied on a sponge and an additional 10 ml is directly applied on the PVC strips. Subsequently, the sponge is made to move back and forth over the PVC strips for a pre-determined number of times (10). After subsequent rinsing of the PVC strips under running tap water, reflectance was measured for each PVC strip using a Superchroma reflectometer and averaged for both PVC strips.

In FIG. 1, a synergy between the micellar phase rhamnolipid biosurfactant mixture (RL) and the sodium salt of the non-glycolipid micellar phase surfactant C12-14 fatty alcohol sulphate (SLS) in the detergent laundry composition according to the present invention can be observed. For example, the detergent composition having a weight ratio SLS/RL of 5:1 has an increased detergency as compared to the detergent composition having a ratio 3:3 (thus both detergent compositions having the same total amount of surfactant). In other words, a synergistic enhancement of the general detergency is observed. As can be observed from FIG. 1, the interaction between micellar phase rhamnolipid and SLS peaks at 3 wt % rhamnolipid.

From FIG. 2, it can be observed that for concentrated applications, the amount of micellar phase sophorolipids (SL) in the detergent composition of the present invention comprising a combination of micellar phase APG650 and SL, determines the hard surface cleaning performance. In diluted applications, the performance loss of sophorolipids is compensated for by the presence of APG650. Thus, a detergent composition containing only sophorolipids (6:0) shows a good performance in concentrated applications (as also demonstrated in prior art), but inferior in diluted applications, which occur more frequently in domestic cleaning. However, as can eb seen from FIG. 2, the detergent compositions according to the present invention in which sophorolipids are combined with APG650 (3:3-4:2) allow for a better performing product in both concentrated as well as diluted applications.

A. Detergent Compositions Comprising Rhamnolipids

### COMPARATIVE EXAMPLE A

In Comparative example A (see Table 1 below), a detergent composition comprising 8 wt % RL (25% active matter ‘AM’) and 3 wt % of the non-glycolipid lamellar phase surfactant Nio3 (100% AM) was tested in a diluted form (0.05 wt % of the detergent composition) for its hard surface cleaning performance. This lamellar surfactant is commonly used in European laundry and cleaning products.

The hard surface cleaning performance was determined by measuring the R_{z} value according to the IPP test as described above.

### EXAMPLES 1-2

In Example 1, a detergent composition comprising 10 wt % RL (25% AM) and 8.33 wt % of the non-glycolipid micellar phase surfactant FAS12 (30% AM) was tested in a diluted form (0.05 wt % of the detergent composition) for its hard surface cleaning performance.

Example 2 was carried out similar to Example 1, using a detergent composition comprising 8 wt % RL (25% AM) and 5 wt % of the non-glycolipid micellar phase surfactant APG650 (50-55% AM).

The hard surface cleaning performance is determined by measuring the Rz value according to the IPP test as described above.

TABLE 1

| | Comparative | | |
|---|---|---|---|
| | Example A | Example 1 | Example 2 |
| RL % | 8 | 10 | 8 |
| Nio3% | 3 | | |
| APG650% | | | 5 |
| FAS12% | | 8.33 | |
| Rz value A | 11.69 | 11.04 | 11.44 |
| Rz value B | 9.62 | 10.82 | 7.53 |
| Average | 10.7 ± 1.1 | 10.9 ± 1.1 | 9.5 ± 1.1 |
| Rz | | | |

RL: JBR425, Rhamnolipid mixture, 25% AM (Jeneil)
Nio3: Marlipal 2430, C12-14 fatty alcohol ethoxylated with 3 mol ethyleneoxide, 100% AM (Sasol)
APG650: Glucopon 650, C8-14 alkylpolyglycoside, dp 1.5, 50-55% AM (Cognis)
FAS12: Neopon LS/LF, C12-14 fatty alcohol sulphate, sodium salt, 30% AM (Ifrachem)

The amounts of the surfactants, each having a different content of active matter, were adjusted such that the detergent compositions of examples 1-2 and of comparative example A had the same total amount of active matter (AM), i.e. active surfactant. It can be calculated that this total amount of active surfactant is 5 wt %.

Table 1 shows that, in a diluted application, the detergent compositions of this invention and the detergent composition of the comparative example A have a comparable hard surface cleaning performance. Note that the confidence intervals were obtained from an Anova on a larger experiment, from which table 1 was extracted.

### COMPARATIVE EXAMPLE B

In Comparative Example B (see Table 2 below), a detergent composition comprising 8 wt % RL (25% AM) and 3 wt % of the non-glycolipid lamellar phase surfactant Nio3 (100% AM) was tested in a concentrated form (0.5 wt % of the detergent composition) for its hard surface cleaning performance.

The hard surface cleaning performance was determined by measuring the R_{z} value according to the IPP test as described above.

### EXAMPLE 3

In Example 3, a detergent composition comprising 8 wt % RL (25% AM) and 5 wt % of the non-glycolipid micellar phase surfactant APG650 (50-55% AM) was tested in a concentrated form (0.5 wt % of the detergent composition) for its hard surface cleaning performance.

The hard surface cleaning performance was determined by measuring the R_{z} value according to the IPP test as described above.

The detergent compositions of example 3 and of comparative example B contain the same total amount of active matter (AM), the total amount of active surfactant being approximately 5 wt %.

Table 2 below shows that, in a concentrated application, the hard surface cleaning performance of the detergent composition according to the present invention is superior to that of the detergent compositions of the comparative example B. Note that the confidence intervals were obtained from an Anova on a larger experiment, from which table 1 was extracted.

TABLE 2

| | Example 3 | Comparative Example B |
|---|---|---|
| RL % | 8 | 8 |
| Nio3% | | 3 |
| APG650% | 5 | |
| FAS12% | | |
| Rz value A | 15.79 | 15.53 |
| Rz value B | 21.03 | 11.81 |
| Average | 18.4 ± 1.1 | 13.7 ± 1.1 |
| Rz | | |

RL: JBR425, Rhamnolipid mixture, 25% AM (Jeneil)
Nio3: Marlipal 2430, C12-14 fatty alcohol ethoxylated with 3 mol ethyleneoxide, 100% AM (Sasol)
APG650: Glucopon 650, C8-14 alkylpolyglycoside, dp 1.5, 50-55% AM (Cognis)
FAS12: Neopon LS/LF, C12-14 fatty alcohol sulphate, sodium salt, 30% AM (Ifrachem)

### COMPARATIVE EXAMPLES C-D

In Comparative Example C (see Table 3 below), a detergent composition comprising a combination of RL (25% AM) and of the non-glycolipid lamellar phase surfactant Nio3 (100% AM) was tested in a concentrated form for its streak-free and gloss retaining window cleaning performance.

Comparative Example D was carried out similar to Comparative Example C, using a detergent composition comprising the non-glycolipid micellar phase surfactants APG215 (62-65% AM) and FAS12 (30% AM), without the presence of a micellar phase glycolipid.

The streak-free and gloss retaining window cleaning performance was measured by determining the gloss retention of black ceramic tiles. The gloss retention is expressed as the quotient between the gloss after cleaning and the initial gloss. The gloss after cleaning was measured after polishing black ceramic tiles 10 times with a Tork paper on which 0.2 ml of the detergent composition has been applied. After 5 minutes drying at room temperature, the gloss after cleaning was measured with a Super 3 Gloss meter in 20° mode.

### EXAMPLE 4

In Example 4, a detergent composition comprising a combination of RL (25% AM) and of the non-glycolipid micellar phase surfactants APG215 (62-62% AM) and FAS12 (30% AM) was tested in a concentrated form for its streak-free and gloss retaining window cleaning performance.

The streak-free and gloss retaining window cleaning performance was measured as described above.

TABLE 3

| | | Comparative | Comparative |
|---|---|---|---|
| | Example 4 | Example C | Example D |
| Ethanol | 10 | 10 | 10 |
| RL (25%) | 0.2 | 0.3 | 0 |
| FAS12 (30%) | 0.2 | 0 | 0.37 |
| APG215 (65%) | 0.4 | 0 | 0.4 |
| Nio3 (100%) | 0 | 0.29 | 0 |
| Water | 89.2 | 89.41 | 89.23 |
| Initial Gloss (av.) | 95.48 | 95.33 | 94.93 |
| Gloss after cleaning (av.) | 93.93 | 85.98 | 93.75 |
| Average gloss retention | 98.38 | 90.19 | 98.76 |

APG215: Glucopon 215 CS UP, C8-10 alkylpolyglycoside, dp 1.6, 62-65% AM (Cognis)
RL: JBR425, Rhamnolipid mixture, 25% AM (Jeneil)
FAS12: Neopon LS/LF, C12-14 fatty alcohol sulphate, sodium salt, 30% AM (Ifrachem)
Nio3: Marlipal 2430, C12-14 fatty alcohol ethoxylated with 3 mol ethyleneoxide, 100% AM (Sasol)

The detergent compositions of example 4 and of comparative examples C-D have the same total amount of active matter (AM), the total amount of active surfactant being approximately 0.36 wt %.

Table 3 shows that the gloss retention for the detergent composition of example 4 is superior to that for the detergent composition of comparative example C, with the environmental benefits of full vegetable origin, lower aquatic toxicity and better biodegradability. Apparently, the combination of the non-glycolipid lamellar phase surfactant Nio3 with the micellar phase rhamnolipid in the detergent composition of comparative example C leaves an unacceptable residue on the surface.

Table 3 further shows that the gloss retention for the detergent composition according to the present invention of example 4 is comparable to that for the detergent composition of comparative example D comprising no micellar phase glycolipid surfactant. In other words, a part of the micellar phase surfactant FAS12 in the detergent composition of Comparative Example D can be replaced by the micellar phase rhamnolipid in the detergent composition of Example 4 without loss of gloss and with the environmental benefit of lower aquatic toxicity.

### COMPARATIVE EXAMPLE E

In Comparative Example E (see table 4 below), a laundry detergent composition comprising a combination of the non-glycolipid micellar phase surfactants FAS1218 (90% AM) and FAE07 (90% AM) was tested for its laundry cleaning performance by measuring the average detergency.

The indicated amounts of the surfactants shown in table 4 were added to a base powder dosage consisting of 3.6 gram sodium soap (palm/coconut 80/20), 4.8 g sodiumdisilicate, 4.8 g Sokalan CP5, 14.4 g sodium carbonate (anhydrous), 30 g zeolite 4A, 49.2 sodiumsulphate (anhydrous) and 1.2 g Wacker ASP15 antifoam.

The average detergency was measured according to the following method. Two Soil Ballast Load swatches (24.5×35 cm, WFK Testgewebe GmbH) were added to a clean and dry wash load of approx. 3.5 kg consisting of 1 blanket, 10 terry towels and 10 kitchen towels. Two soil monitors consisting of 10D, 20D and AS9 (each 10×10, CFT BV) were attached (with staples along two sides) to one of the kitchen towels. After the full wash cycle (main program) the wash load was transferred to the next washing machine, thus allowing the laundry compositions to be tested simultaneously in a Bauknecht Stuttgart 1000, two AEG72730 machine and an AEG6954. Wash tests were not replicated on the same machine and were performed at 60° C., 20° fH water hardness. Average detergency was calculated as the average over the 3 soil monitors in the four machines.

### EXAMPLE 5

In Example 5, a laundry detergent composition according to the present invention comprising a combination of RL (25% AM) and the non-glycolipid micellar phase surfactant FAS1218 (90% AM) was tested for its laundry cleaning performance by measuring the average detergency according to the method described above.

The indicated amounts of the surfactants shown in table 4 were added to a base powder dosage consisting of 3.6 gram sodium soap (palm/coconut 80/20), 4.8 g sodiumdisilicate, 4.8 g Sokalan CP5, 1.2 g Wacker ASP15 antifoam, 14.4 g sodium carbonate (anhydrous), 30 g zeolite 4A and 49.2 sodiumsulphate (anhydrous).

Care as taken that the detergent compositions of example 5 and comparative example E contain substantially the same total amount of active matter (AM) of approximately 13.00 wt %.

Table 4 shows that the average detergency for the detergent composition according to the present invention of example 5 is comparable to that for the detergent composition of comparative example E comprising no micellar phase glycolipid surfactant. In other words, the micellar phase surfactant FAE07 in the detergent composition of Comparative Example E can be replaced by the micellar phase rhamnolipid in the detergent composition of Example 5 without loss of performance, the detergent composition of Example 5 presenting the environmental benefits of full vegetable origin, lower aquatic toxicity and better biodegradability.

TABLE 4

| | Comparative Example E | Example 5 |
|---|---|---|
| FAS1218 (g) | 9.1 | 10.3 |
| FAEO7 (g) | 5.33 | 0 |
| RL (g) | 0 | 14.4 |
| Active matter (g) | 12.99 | 12.87 |

AEG 1

| | | |
|---|---|---|
| AS9 Y value | 62.91 | 64.52 |
| 20D Y value | 67.5 | 67.48 |
| 10D Y value | 63.95 | 64.9 |

Bauknecht

| | | |
|---|---|---|
| AS9 Y value | 64.28 | 66.5 |
| 20D Y value | 70.52 | 67.34 |
| 10D Y value | 66.68 | 64.35 |

AEG 2

| | | |
|---|---|---|
| AS9 Y value | 64.72 | 62.84 |
| 20D Y value | 70.29 | 67.24 |
| 10D Y value | 63.24 | 61.44 |

AEG 6954

| | | |
|---|---|---|
| AS9 Y value | 64.67 | 64.29 |
| 20D Y value | 70.16 | 71.75 |
| 10D Y value | 67.35 | 62.27 |

Average

| | | |
|---|---|---|
| AS9 average Y | 64.15 | 64.54 |
| 20D average Y | 69.62 | 68.45 |
| 10D average Y | 65.31 | 63.24 |
| Average detergency | 66.36 ± 0.58 | 65.41 ± 0.58 |

FAS1218: = Sulfopon 1218, C12-18 fatty alcohol sulphate, sodium salt, 90% AM (Cognis)
FAEO7: Marlipal 2479, C12-14 fatty alcohol ethoxylated with 7 mol ethyleneoxide, 90% AM (Sasol)
RL: JBR425, Rhamnolipid mixture, 25% AM (Jeneil)

B. Detergent Compositions Comprising Sophorolipids

### COMPARATIVE EXAMPLE a

In Comparative Example a (see Table I below), 0.5 ml of a 10 wt % SLS (30% AM) solution was added to a cylinder containing 100 ml of cold tap water. After shaking the cylinder with a stopper ten times upside down, the foam height in time was measured.

The foam height of the various detergent compositions was measured by adding a detergent composition to a cylinder containing 100 ml of cold tap water having a hardness of 20° fH, shaking the cylinder with a stopper ten times upside down. The foam height was measured immediately (o min), 2, 5 and 10 min after shaking.

### EXAMPLES I-II

In Example I, 0.5 ml of a 10 wt % SLS (30% AM) solution combined with 0.1 ml SL (65% AM) was added to a cylinder containing 100 ml of cold tap water. After shaking the cylinder with a stopper ten times upside down, the foam height in time was measured as described above.

Example II was carried out similar to Example I, using 0.5 ml of a 10 wt % SLS solution combined with 0.4 ml SL.

Example III was carried out similar to Example I, using 0.5 ml of a 10 wt % SLS combined with 0.5 ml SL.

TABLE I

| | | Foam height (cm) after | | | |
|---|---|---|---|---|---|
| | | 0 min | 2 min | 5 min | 10 min |
| Comparative | 0.5 ml SLS 10% + 0 ml | 5.5 | 4.5 | 3.7 | 3.5 |
| Example a | SL | | | | |
| Example I | 0.5 ml SLS 10% + 0.1 ml | 3.5 | 1.0 | 0.5 | 0.5 |
| | SL | | | | |
| Example II | 0.5 ml SLS 10% + 0.4 ml | 3.0 | 0.3 | 0.1 | 0.1 |
| | SL | | | | |
| Example III | 0.5 ml SLS 10% + 0.5 ml | 2.0 | 0.1 | 0.1 | 0.0 |
| | SL | | | | |

SL: Sopholiance, sophorolipid from methylester of rapeseed oil, 65% AM (Soliance)
SLS: Neopon LS/LF, C12-14 fatty alcohol sulphate, sodium salt, 30% AM

Table I shows that, when using 0.5 ml of a 10 wt % SLS solution combined with 0.1 ml SL of example I,

1) after 10 min the height of the foam is reduced more completely as compared to when using 0.5 ml of a 10 wt % SLS of comparative example I. Indeed, after 10 minutes, the foam height is reduced by approximately 86% when using 0.5 ml of a 10 wt % SLS solution combined with 0.1 ml SL of example 1, as compared to 37% when using 0.5 ml of a 10 wt % SLS of comparative example a

2) the decrease of foam height that is already achieved after 2 min as a percentage of the total decease in foam height is larger as compared to when using 0.5 ml of a 10 wt % SLS of comparative example a. Indeed, 83% of the total decrease of foam height is already achieved after 2 min when using 0.5 ml of a 10 wt % SLS solution combined with 0.1 ml SL of example I, as compared to only 51% when using 0.5 ml of a 10 wt % SLS.

3) the height of the foam at each time point is smaller as compared to that when using 0.5 ml of a 10 wt % SLS of comparative example a.

Table I shows that, when using 0.5 ml of a 10 wt % SLS solution combined with 0.4 ml SL of example II,

1) after 10 min the height of the foam is reduced more completely as compared to when using 0.5 ml of a 10 wt % SLS solution combined with 0.1 ml SL of example I, and thus also as compared to when using 0.5 ml of a 10 wt % SLS of comparative example a.

2) the decrease of foam height that is already achieved after 2 min as a percentage of the total decease in foam height is larger as compared to when using 0.5 ml of a 10 wt % SLS solution combined with 0.1 ml SL of example I, and thus also as compared to when using 0.5 ml of a 10 wt % SLS of comparative example a.

3) the height of the foam at each time point is smaller as compared to that when using 0.5 ml of a 10 wt % SLS solution combined with 0.1 ml SL of example I, and consequently also as compared to that when using 0.5 ml of a 10 wt % SLS solution of Comparative Example a.

Table I further shows that when using 0.5 ml of a 10 wt % SLS solution combined with 0.5 ml SL of Example III,

1) after 10 min the height of the foam is reduced more completely as compared to when using 0.5 ml of a 10 wt % SLS solution combined with 0.4 ml SL of example II, and consequently also as compared to when using 0.5 ml of a 10 wt % SLS solution combined with 0.1 ml SL of example I, and consequently also as compared to the height of the foam generated when using 0.5 ml of a 10 wt % SLS solution of Comparative Example a.

2) the decrease of foam height that is already achieved after 2 min as a percentage of the total decease in foam height is larger as compared to when using 0.5 ml of a 10 wt % SLS solution combined with 0.4 ml SL of Example II, and consequently also as compared to when using 0.5 ml of a 10 wt % SLS solution combined with 0.1 ml SL of example I, and consequently also as compared to the height of the foam generated when using 0.5 ml of a 10 wt % SLS solution of Comparative Example a.

3) the height of the foam at each time point is smaller as compared to that when using 0.5 ml of a 10 wt % SLS solution combined with 0.4 ml SL of Example II, and consequently also as compared to that when using 0.5 ml of a 10 wt % SLS solution combined with 0.1 ml SL of example I, and consequently also as compared to that when using 0.5 ml of a 10 wt % SLS solution of Comparative Example a.

The previous examples I-III all demonstrate the same principle, being that sophorolipids have the ability of quickly and completely breaking foam. Thus, the higher the amount of sophorolipids in the detergent compositions (examples I throughout III), the more quickly and completely the height of the generated foam is reduced. Similar results were obtained when, instead of cold tapwater, warm water was used.

### COMPARATIVE EXAMPLE b

In Comparative Example b (see Table II below), 0.5 ml of a 1 wt % APG (x % AM) solution was added to a cylinder containing 100 ml of tap water. After shaking the cylinder with a stopper ten times upside down, the foam height in time was measured as described above.

### EXAMPLES IV-V

In Example IV (see Table II below), 0.5 ml of a 1 wt % APG (50% AM) solution combined with 0.4 ml SL (65% AM) was added to a cylinder containing 100 ml of tap water. After shaking the cylinder with a stopper ten times upside down, the foam height in time was measured as described above.

Example V was carried out similar to Example IV, using 0.5 ml of a 1 wt % APG solution combined with 0.5 ml SL.

TABLE II

| | | Foam height (cm) after | | | |
|---|---|---|---|---|---|
| | | 0 min | 2 min | 5 min | 10 min |
| Comparative | 0.5 ml APG 1% + 0 ml | 3.8 | 3.5 | 3.5 | 3.5 |
| Example b | SL | | | | |
| Example IV | 0.5 ml APG 1% + 0.4 ml | 5.5 | 2.0 | 1.1 | 0.7 |
| | SL | | | | |
| Example V | 0.5 ml APG 1% + 0.5 ml | 3.5 | 0.7 | 0.4 | 0.3 |
| | SL | | | | |

SL: Sopholiance, sophorolipid from methylester of rapeseed oil, 65% AM (Soliance)
APG: Glucopon 600 UP, C8-16 alkylpolyglycoside, dp 1.4, 50-55% AM (Cognis)

Table II shows that, when using 0.5 ml of a 1 wt % APG solution combined with 0.4 ml SL of example IV,

1) after 10 min the height of the foam is reduced more completely as compared to when using 0.5 ml of a 1 wt % APG of comparative example b.

2) the decrease of foam height that is already achieved after 2 min as a percentage of the total decease in foam height is larger as compared to when using 0.5 ml of a 1 wt % APG of comparative example b.

3) the height of the foam at each time point is smaller as compared to that when using 0.5 ml of a 1 wt % APG of comparative example b.

Table II shows that, when using 0.5 ml of a 1 wt % APG solution combined with 0.5 ml SL of example V,

1) after 10 min the height of the foam is reduced more completely as compared to when using 0.5 ml of a 1 wt % APG solution combined with 0.4 ml SL of example IV, and thus also as compared to when using 0.5 ml of a 1 wt % APG of comparative example b.

2) the decrease of foam height that is already achieved after 2 min as a percentage of the total decease in foam height is larger as compared to when using 0.5 ml of a 1 wt % APG solution combined with 0.4 ml SL of example IV, and thus also as compared to when using 0.5 ml of a 1 wt % APG of comparative example b.

3) the height of the foam at each time point is smaller as compared to the height of the foam generated when using 0.5 ml of a 1 wt % APG solution combined with 0.4 ml SL of example IV, and consequently also as compared to the height of the foam generated when using 0.5 ml of a 1 wt % APG solution of Comparative Example b.

The previous examples IV-V demonstrate the same principle, being that sophorolipids have the ability of quickly and completely breaking foam. Thus, the higher the amount of sophorolipids in the detergent compositions (example IV vs. V), the more quickly and completely the height of the generated foam is reduced. Similar results were obtained when, instead of cold tapwater, warm water was used.

Without wanting to be limited thereto, the inventors are of the opinion that the quick and complete foam breaking effect of micellar phase sophorolipids is due to the binding of hard water ions such as calcium to the carboxylgroup of free acid sophorolipids. The latter is supported by the lack of a foam breaking effect by micellar phase sophorolipids in softened water having a low concentration of calcium ions. The foam breaking effect does not seem to be caused by an ionic interaction among surfactants, since it occurs when using sophorolipids in combination both with anionic SLS (Examples I-III) as well as with non-ionic APG (examples IV-V).

### COMPARATIVE EXAMPLE c

In Comparative Example c, a non-aqueous D-limonene-based detergent composition comprising 6.67 wt % of the non-glycolipid micellar phase surfactant FAE07 (100% AM) and 3.33 wt % of the non-glycolipid micellar phase surfactant APG225 (70% AM) was tested in a concentrated form for its storage stability at 40° C. during 1 month and for their hard surface cleaning performance, in particular its ability for removing stain.

The hard surface cleaning performance was measured by determining the Rz values according to the IPP test. Concentrated (0.5% active) samples were tested in duplicate without pH adjustment for their hard surface cleaning ability according to the IPP Quality test, applying 10 ml of the sample on a sponge and 10 ml directly on a PVC strip (85×432 mm) soiled with a 150 micron layer of mineral oil and carbon black. Following 90 minutes drying at room temperature and subsequent mechanical cleaning on a Gardner device and rinsing under running tapwater, four R_{z} values were measured for each PVC strip using a Superchroma reflectometer.

### EXAMPLES VI-VII

In Example VI, a non-aqueous D-limonene-based detergent composition comprising 3.33 wt % SL (65% AM) and 6.67 wt % of the non-glycolipid micellar phase surfactant FAE07 (100% AM) was tested in a concentrated form for their storage stability at 40° C. during 1 month and for their hard surface cleaning performance, in particular for its stain removing ability.

Example VII was carried out similar to Example VI, using a detergent composition comprising 0.167 wt % SL, 6.67 wt % of the non-glycolipid micellar phase surfactant FAE07 and 0.167 wt % of the non-glycolipid micellar phase surfactant APG225 (70% AM). Although ethoxylated non-ionic surfactants are generally considered to be lamellar phase surfactants, the ethoxylated non-ionic surfactant FAEO7 is a micellar phase surfactant since it provides a clear solution when present at a concentration of 1% by weight in demineralised water at pH 7.0 and 25° C. with a HLB value well in excess of 10.5.

The hard surface cleaning performance was measured by determining the Rz values as described above.

The detergent compositions of examples VI-VII and of comparative example c have substantially the same total amount of active matter (AM), i.e. active surfactant. It can be calculated that this total amount of active surfactant is approximately 9 wt %.

TABLE III

| | Comparative example c | Example VI | Example VII |
|---|---|---|---|
| Limonene % | 90 | 90 | 90 |
| SL % | 0 | 3.33 | 0.167 |
| APG225% | 3.33 | 0 | 0.167 |
| FAEO7% | 6.67 | 6.67 | 6.67 |
| Rz value strip A | 36.42 | 35.39 | 33.41 |
| Rz value strip B | 33.15 | 36.44 | 32.08 |
| Average Rz value | 34.78 | 35.91 | 32.75 |
| Soil removal | 95.12 | 95.44 | 94.49 |
| Visual aspect | Stable | Stable | Stable |

FAEO7: Marlipal 2470, C12-14 fatty alcohol ethoxylated with 7 mol ethyleneoxide, 100% AM (Sasol)
APG225: Glucopon 225 DK, C8-10 alkylpolyglycoside, dp 1.7, 70% AM (Cognis)
SL: Sopholiance, sophorolipid from methylester of rapeseed oil, 65% AM (Soliance)

Table III shows that the hard surface cleaning performance for the detergent composition according to the present invention of example VI is comparable to that for the detergent composition of comparative example c comprising no micellar phase sophorolipid surfactant. In other words, the micellar phase surfactant APG225 in the detergent composition of Comparative Example c can be replaced by the micellar phase sophorolipid in the detergent composition of Example VI without loss of performance, and with the environmental benefit of lower aquatic toxicity.

Table III further shows that the hard surface cleaning performance for the detergent composition according to the present invention of example VII is comparable to that for the detergent composition of comparative example c comprising no micellar phase sophorolipid surfactant. In other words, part of the micellar phase surfactant APG225 in the detergent composition of Comparative Example c can be replaced by the micellar phase sophorolipid in the detergent composition of Example VII without loss of performance and without loss of micro-emulsion storage stability.

### COMPARATIVE EXAMPLE d

In Comparative Example d (see Table 4 below), a detergent composition comprising 5 wt % SL (65% AM) and 2 wt % of the non-glycolipid lamellar phase surfactant Nio3 (100% AM) was tested in a diluted form for its hard surface cleaning performance.

The hard surface cleaning performance is determined by measuring the R_{z} value according to the IPP test as described above.

### EXAMPLE VII

In Example VIII, a detergent composition comprising 5 wt % SL (65% AM) and 4 wt % of the non-glycolipid micellar phase surfactant APG650 (50-55% AM) was tested in a diluted form for its hard surface cleaning performance.

The hard surface cleaning performance is determined by measuring the R_{z} value according to the IPP test as described above.

TABLE IV

| | Example VIII | Comparative Example d |
|---|---|---|
| SL % | 5 | 5 |
| Nio3% | | 2 |
| APG650% | 4 | |
| Rz value A | 12.43 | 7.22 |
| Rz value B | 13.19 | 6.57 |
| Average Rz | 12.8 ± 1.1 | 6.9 ± 1.1 |

SL: Sopholiance, sophorolipid from methylester of rapeseed oil, 65% AM (Soliance)
Nio3: Marlipal 2430, C12-14 fatty alcohol ethoxylated with 3 mol ethyleneoxide, 100% AM (Sasol)
APG650: Glucopon 650, C8-14 alkylpolyglycoside, dp 1.5, 50-55% AM (Cognis)

The detergent compositions of example VIII and of comparative example d have substantially the same total amount of active matter (AM), i.e. active surfactant. It can be calculated that this total amount of active surfactant is approximately 5.25 wt %.

Table IV shows that, in a diluted application, the hard surface cleaning performance of the detergent composition according to the present invention of example VIII comprising micellar phase sophorolipids and a non-glycolipid micellar phase surfactant is superior to that of the detergent composition of the comparative example d comprising micellar phase sophorolipids and a non-glycolipid lamellar phase surfactant.

### COMPARATIVE EXAMPLE e

In Comparative Example e (see Table 5 below), a detergent composition comprising 5 wt % SL (65% AM) and 2 wt % of the non-glycolipid lamellar phase surfactant Nio3 (100% AM) was tested in a concentrated form for its hard surface cleaning performance.

The hard surface cleaning performance is determined by measuring the R_{z} value according to the IPP test as described above.

### EXAMPLE IX

In Example IX, a detergent composition comprising 5 wt % SL (65% AM) and 4 wt % of the non-glycolipid micellar phase surfactant APG650 (50-55% AM) was tested in a concentrated form for its hard surface cleaning performance as described above.

TABLE V

| | Example IX | Comparative Example e |
|---|---|---|
| SL % | 5 | 5 |
| Nio3% | | 2 |
| APG650% | 4 | |
| Rz value A | 36.39 | 31.73 |
| Rz value B | 41.55 | 31.21 |
| Average Rz | 39.0 ± 1.1 | 31.5 ± 1.1 |

RL: JBR425, Rhamnolipid mixture, 25% AM (Jeneil)
SL: Sopholiance, sophorolipid from methylester of rapeseed oil, 65% AM (Soliance)
Nio3: Marlipal 2430, C12-14 fatty alcohol ethoxylated with 3 mol ethyleneoxide, 100% AM (Sasol)
APG650: Glucopon 650, C8-14 alkylpolyglycoside, dp 1.5, 50-55% AM (Cognis)

The detergent compositions of example IX and of comparative example e have the same total amount of active matter (AM), i.e. active surfactant. It can be calculated that this total amount of active surfactant is approximately 5.25 wt %.

Table V shows that, in a concentrated application, the hard surface cleaning performance of the detergent composition according to the present invention of example IX comprising micellar phase sophorolipids and a non-glycolipid micellar phase surfactant is superior to that of the detergent composition of the comparative example e comprising micellar phase sophorolipids and a non-glycolipid lamellar phase surfactant.

1. A detergent composition comprising at least one glycolipid biosurfactant and at least one non-glycolipid surfactant, characterized in that the at least one glycolipid biosurfactant and the at least one non-glycolipid surfactant are in the micellar phase.

2. The detergent composition as claimed in claim 1, characterized in that the glycolipid micellar phase biosurfactant is either a sophorolipid biosurfactant of the formula (I): 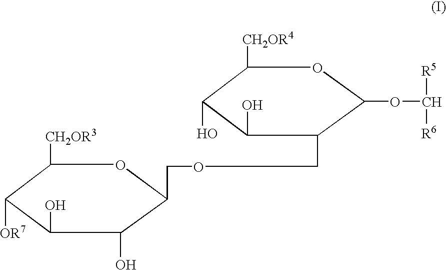
in which
—R³ and R⁴ are independently from each other H or an acetyl group;
—R⁵ is H or a saturated or unsaturated, hydroxylated or non-hydroxylated hydrocarbon group having 1 to 9 carbon atoms;
—R⁶ is the group R⁸—CO—R⁹ or the group 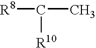
whereby R⁸ is a saturated or an unsaturated, hydroxylated or non-hydroxylated, linear or branched hydrocarbon group having 1 to 20 carbon atoms, the total number of carbon atoms in the groups R⁵ and R⁸ not exceeding 20; R⁹ is CH₃ or OH or cation salt thereof, or an O(CH₂)ₘCH₃ ester thereof with m being an integer between 0 and 3, or a lactone ring formed with R⁷; R¹⁰ is H or OH; —R⁷ is H or a lactone ring formed with R⁹;
or
a rhamnolipid biosurfactant of the formula (II): 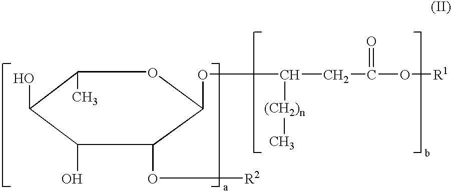
in which a and b independently from each other are 1 or 2, n is an integer from 4 to 10, R¹ is H or a cation, preferably H, R² is H or the group
CH₃(CH₂)ₘCH═CH—CO
preferably H, m being an integer from 4 to 10, and m and n may be the same or different; or a combination of the micellar phase sophorolipid and rhamnolipid biosurfactant.

3. The detergent composition as claimed in claim 2, characterized in that the glycolipid micellar phase biosurfactant is a sophorolipid biosurfactant corresponding to the formula (III): 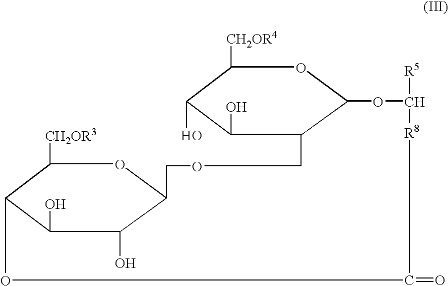
in which R³, R⁴, R⁵ and R⁸ are as defined in formula (I), and whereby at least one of R³ and R⁴ is an acetyl group.

4. The detergent composition as claimed in any one of claims 2-3, characterized in that the glycolipid micellar phase biosurfactant is a sophorolipid biosurfactant and R⁵ is a methyl group.

5. The detergent composition as claimed in any one of claims 2-4, characterized in that the glycolipid micellar phase biosurfactant is a sophorolipid biosurfactant whereby R⁶ is the group R⁸—CO—R⁹ and the total number of carbon atoms of R⁵ and R⁸ is from 6 to 20, R⁵, R⁶, R⁸ and R⁹ being as defined in formula (I).

6. The detergent composition as claimed in claim 5, characterized in that R⁵ is CH₃ and R⁸ is an unsaturated linear hydrocarbon chain having 13-15 carbon atoms or a saturated linear hydrocarbon chain having 6-9 carbon atoms.

7. The detergent composition as claimed in any one of claims 2 or 4, characterized in that the glycolipid micellar phase biosurfactant is a sophorolipid biosurfactant corresponding to the formula: 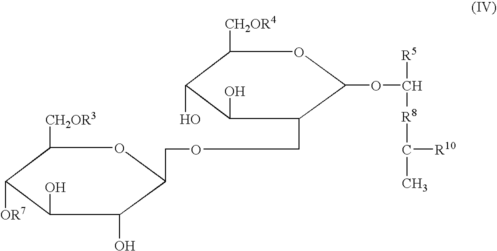
in which R³, R⁴, R⁵, R ⁸and R¹⁰ are as defined in formula (I).

8. The detergent composition as claimed in claim 7, characterized in that R⁵ is CH₃, R¹⁰ is H and R⁸ is a saturated linear hydrocarbon group having 8-10 carbon atoms.

9. The detergent composition as claimed in any one of claims 2-8, characterized in that the glycolipid micellar phase biosurfactant is a rhamnolipid biosurfactant and n is 6.

10. The detergent composition as claimed in any one of claims 2-9, characterized in that the glycolipid micellar phase biosurfactant is a rhamnolipid biosurfactant and b is 2.

11. The detergent composition as claimed in any one of claims 1-10, characterized in that the non-glycolipid micellar phase surfactant is selected from the group of anionic, cationic, amphoteric and non-ionic surfactants, or a combination thereof.

12. The detergent composition as claimed in any one of claims 1-11, characterized in that the weight ratio of the glycolipid micellar phase biosurfactant to the non-glycolipid micellar phase surfactant is within the range of 1:7 to 10:1.

13. The detergent composition as claimed in any one of claims 1-12, characterized in that the weight ratio of the glycolipid micellar phase rhamnolipid biosurfactant to the non-glycolipid micellar phase surfactant is within the range 1:7 to 2:1, preferably 1.25:1 to 1:1.25.

14. The detergent composition as claimed in any one of claims 1-12, characterized in that the weight ratio of the glycolipid micellar phase sophorolipid biosurfactant to the non-glycolipid micellar phase surfactant is within the range 1:2 to 10:1 or 1:4 to 4: 1, preferably 2:1.

15. The detergent composition as claimed in any one of claims 1-14, characterized in that the amount of the glycolipid micellar phase biosurfactant is within the range of 0.05-5.0% by weight with respect to the total weight of the composition.

16. The detergent composition as claimed in any one of claims 1-15, characterized in that the amount of the glycolipid micellar phase biosurfactant and non-glycolipid micellar phase surfactant together is from 0.3-30 % by weight with respect to the total weight of the composition.

17. The detergent composition as claimed in any one of claims 1-16, characterized in that the composition further comprises a non-glycolipid surfactant which is in the lamellar phase.

18. The detergent composition as claimed in claim 17, characterized in that the lamellar phase non-glycolipid surfactant is an ethoxylated non-ionic surfactant.

19. The detergent composition as claimed in any one of claims 1-18, characterized in that the liquid detergent composition is an aqueous or non-aqueous composition.

20. A hard surface cleaning detergent composition comprising an amount of the detergent composition as claimed in any one of claims 1-19.

21. A laundry composition comprising an amount of the detergent composition as claimed in any one of claims 1-19.
